(19) United States
(12) Patent Application Publication
(10) Pub. No.: US 2019/0238319 A1
(43) Pub. Date: Aug. 1, 2019

(54) RIGHTS MANAGEMENT OF CONTENT

(71) Applicant: Michael Beck, New York, NY (US)

(72) Inventor: Michael Beck, New York, NY (US)

(21) Appl. No.: 16/262,528

(22) Filed: Jan. 30, 2019

Related U.S. Application Data
(60) Provisional application No. 62/623,832, filed on Jan. 30, 2018.

(51) Int. Cl. H04L 9/06; H04L 9/08; G06F 21/60; G06F 21/10; G06Q 20/36

(52) U.S. Cl. CPC H04L 9/0637; H04L 9/0819; G06F 21/602; G06F 21/10; G06Q 2220/00; H04L 2209/38; G06F 2221/0753; H04L 2209/56; G06Q 20/3678

(57) ABSTRACT

Data characterizing a secure rights managed container can be received. The secure rights managed container can include a first content holder. The first content holder can include a first content, first terms and conditions, and a symmetric key. The first content can be encrypted by the symmetric key and configured to enable a modification of a blockchain. The first terms and conditions can specify access to the first content, and the symmetric key can be encrypted by a public key of a clearing server. A first context of a recipient and a first credential of the recipient can be received. The clearing server can determine access to the first content by the recipient at least by comparing the first terms and conditions to the first context and the first credential. The first content can be provided to the recipient for executing the modification of the blockchain.

### CROSS-REFERENCE TO RELATED APPLICATIONS

This application claims the benefit of U.S. Provisional Application No. 62/623,823, filed Jan. 30, 2018, the contents of which are hereby fully incorporated by reference.

### TECHNICAL FIELD

The subject matter described herein relates to rights management of content.

### BACKGROUND

A blockchain can include a growing list of records, or blocks, which can be linked using cryptography. Each block can include a cryptographic hash of the previous block, a timestamp, and content. The cryptographic hash of a previous block can link a current block to the previous block, forming a chain. Because of this cryptographic hash chain design, a blockchain can be resistant to modification of the data.

### SUMMARY

In an aspect, data characterizing a secure rights managed container can be received. The secure rights managed container can include a first content holder. The first content holder can include a first content, first terms and conditions, and a symmetric key. The first content can be encrypted by the symmetric key and configured to enable a modification of a blockchain. The first terms and conditions can specify access to the first content, and the symmetric key can be encrypted by a public key of a clearing server. A first context of a recipient and a first credential of the recipient can be received. The clearing server can determine access to the first content by the recipient at least by comparing the first terms and conditions to the first context and the first credential. The first content can be provided to the recipient for executing the modification of the blockchain.

One or more of the following features can be included in any feasible combination. For example, the clearing server can use a private key of the clearing server to decrypt the symmetric key. The clearing server can use the decrypted symmetric key to decrypt the first content. The decrypted first content can be provided to the recipient. The clearing server can generate a session key between the recipient and the clearing server. The clearing server can use the session key to encrypt the first content. The encrypted first content can be provided to the recipient.

Data characterizing the first content and the first terms and conditions can be received. The generation server can generate the symmetric key. The generation server can encrypt the first content. The generation server can use the public key of the clearing server to encrypt the symmetric key. The generation server can package the encrypted first content, the first terms and conditions, and the encrypted symmetric key into the first content holder. The secure rights managed container including the first content holder can be provided. The modification of the blockchain can be executed.

The first content can include a first digital cryptocurrency unit of exchange, metadata, a first cryptocurrency address associated with the first digital cryptocurrency unit of exchange, a first private key associated with the first digital cryptocurrency unit of exchange, and/or supporting content for transmission between a sender and the recipient. The first terms and conditions can include a passcode, a claim id, a geo-fenced location of attempted access, a geo-gridded location of attempted access, a time, a network address, a device network card address, a MAC address, a shared password, and/or other secrets. The first context can include a geo-fenced location of attempted access, a geo-gridded location of attempted access, a time, a network address, a MAC address, and/or a device network card address and the first credential includes a passcode, a claim id, a shared password, a one-time password, a public key, and/or other secrets.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system block diagram illustrating an example system that facilitates secure distribution of content;

FIG. 2 is a system block diagram illustrating an example implementation of a secure rights managed container; and

FIG. 3 is a process flow diagram illustrating an example process for secure distribution of content.

Like reference symbols in the various drawings indicate like elements.

### DETAILED DESCRIPTION

A blockchain can be resistant to modification of data. As a result, any modification to content stored on an existing block of the blockchain must be included in a new block appended to the end of the blockchain. With enough modifications to the content, including miniscule modifications that wouldn't significantly alter the size of a different data structure, or even decrease the size of such a data structure, the size of the blockchain can grow exponentially. And the mechanism utilized to append a block to the blockchain can be computationally intensive and expensive. Thus, it can be desirable to combine modifications to content stored in the blockchain.

In some implementations of the current subject matter, many modifications to content stored in the blockchain can be combined into a single modification to the content stored in the blockchain. For example, a modification to content stored in the blockchain can occur when digital cryptocurrency is exchanged. If an exchange includes more than one intermediary, redundant modifications can be reflected in the blockchain. Some implementations of the current subject matter can reduce blockchain storage size and computational overhead by facilitating the secure exchange of content by packaging the content in a rights managed container. By packaging the content in a rights managed container, redundant modifications to the blockchain can be truncated. As a result, the cost associated with storage and computation of the blockchain can be reduced. In some example implementations, the content can include digital cryptocurrency (e.g., Bitcoin and/or the like. In some example implementations, the content can include credentials to application programming interfaces (APIs) that can provide access to private keys and associated addresses.

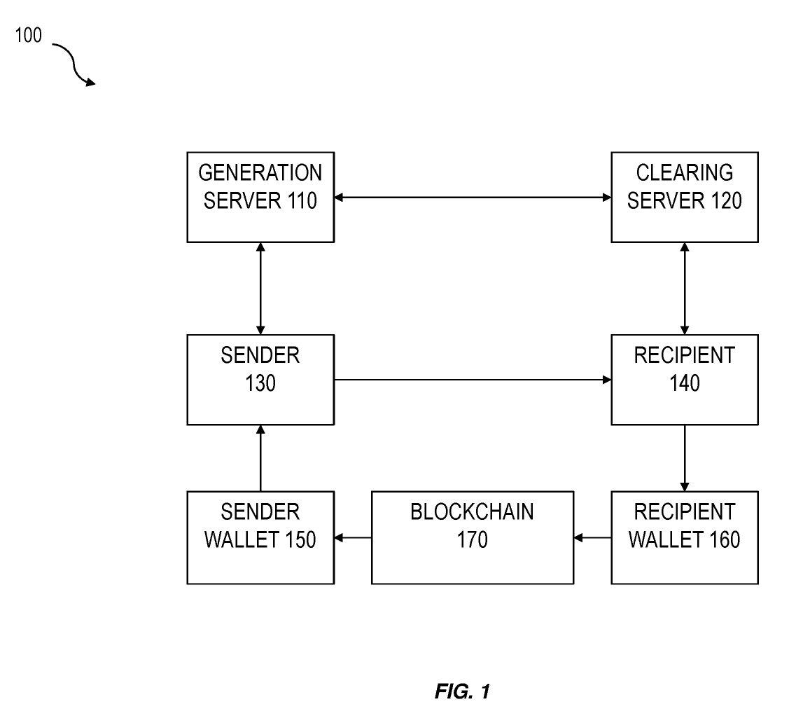

FIG. 1 is a system block diagram illustrating an example implementation of system 100 that facilitates secure distribution of content, such as digital cryptocurrency. System 100 can include a generation server 110, a clearing server 120, a sender 130, a sender wallet 150, a recipient 140, a recipient wallet 150, and a blockchain 170. By utilizing secure rights managed containers, generation server 110, and clearing server 120, content can be distributed securely from sender 130 to recipient 140, redundant modifications to the blockchain can be avoided, and the cost associated with storage and computation of the blockchain can be reduced.

Generation server 110 can facilitate packaging a secure rights managed container. Generation server 110 can include an address for one or more contents packaged within the secure rights managed container. Clearing server 120 can manage access to the secure rights managed containers by utilizing terms and conditions, such as access policies. Sender 130 can package content using the generation server 110.

Recipient 140 can receive packaged content and/or request access to packaged content from clearing server 120. Sender wallet 150 can include an address stored on the blockchain signifying a previous modification to the blockchain including sender 130 and a private key for a future modification by Recipient 140. Recipient wallet 160 can include an address at which Recipient 140 can conclude a modification of the blockchain and a public key for verification of the modification to blockchain 170. Upon the exchange of content from sender 130 to recipient 140, a modification can be executed and recorded in blockchain 170. Generation server 110, clearing server 120, sender 130, recipient 140, sender wallet 150, recipient wallet 160, and blockchain 170 will be discussed below.

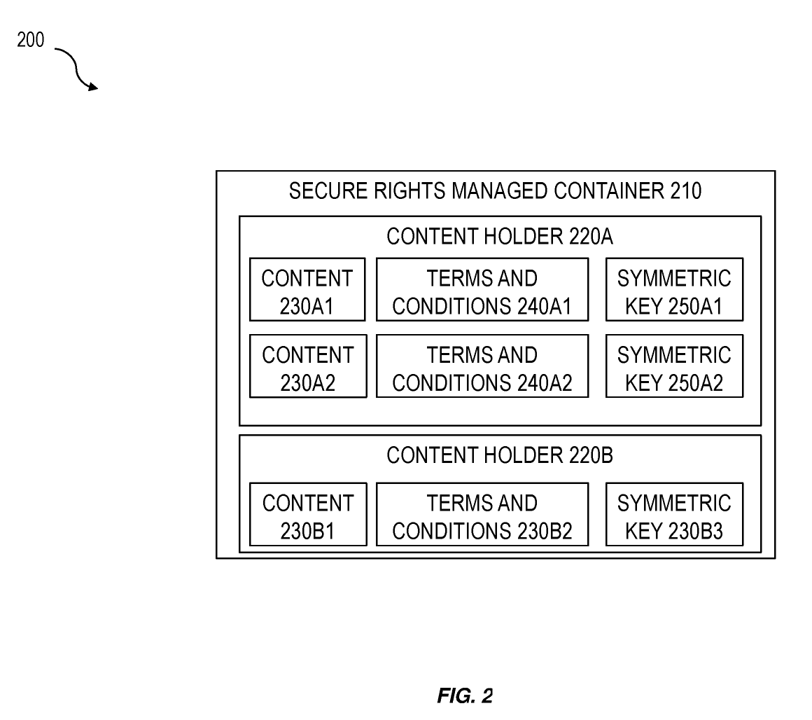

FIG. 2 is a system block diagram illustrating an example implementation of secure rights managed container 210. By utilizing secure rights managed containers, content can be distributed securely from sender 130 to recipient 140, redundant modifications to the blockchain can be avoided, and the cost associated with storage and computation of the blockchain can be reduced. Secure rights managed container 210 can include content holder 220. Secure rights managed container 210 can manage access to content in content holder 220. Content holder 220 can facilitate reassignment of content. Content holder 220 can include content 230, terms and conditions 240, and symmetric key 250.

Content 230 can include a first unit of exchange, metadata, a first address associated with the first unit of exchange, a first private key associated with the first unit of exchange, supporting content for transmission between a sender and the recipient, and/or the like.

Terms and conditions 240 can include a passcode, a claim identifier (ID), a geo-fenced location of attempted access, a geo-gridded location of attempted access, a time, a network address, a device network card address, a MAC address, a shared password, other secrets, include a passcode, a claim id, a geo-fenced location of attempted access, a geo-gridded location of attempted access, a time, a network address, a device network card address, a MAC address, a shared password, and/or other secrets.

Symmetric key 250 can include a cryptographic key for both encryption of plaintext (e.g., first content) and decryption of ciphertext (e.g., encrypted first content in content holder). The key can represent a shared secret between two or more parties (e.g., generation server, clearing server, sender, recipient, and/or the like) that can be used to maintain a private information link.

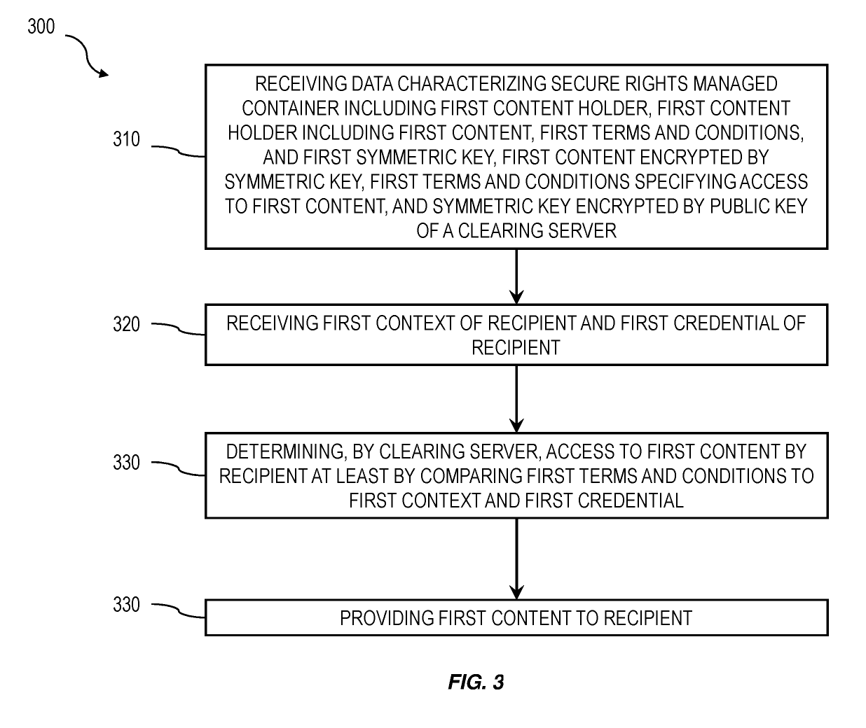

FIG. 3 is a process flow diagram illustrating an example process facilitating secure distribution of content. By utilizing secure rights managed containers, content, such as credentials (e.g., private key, address, symmetric key, other forms of authentication, and/or the like) can be distributed securely from sender 130 to recipient 140, redundant modifications to the blockchain can be avoided, and the cost associated with storage and computation of the blockchain can be reduced.

At 310, data characterizing secure rights managed container 210 can be received (e.g., from recipient 140). Secure rights managed container 210 can include content holder 220. Content holder 220 can include content 230, terms and conditions 240, and symmetric key 250. Content 230 can be encrypted (e.g., at generation server 110) by symmetric key 250. Content 230 can include digital cryptocurrency units of exchange, metadata, cryptocurrency addresses, private keys associated with addresses, supporting content for transmission between sender 130 and recipient 140, and/or the like. Terms and conditions 240 can specify access to content 230. Terms and conditions 240 can include a passcode, a claim id, a geo-fenced location of attempted access, a geo-gridded location of attempted access, a time, a network address, a device network card address, a MAC address, a shared password, other secrets, and/or the like. Symmetric key 250 can be encrypted by a public key of clearing server 120.

At 320, context of recipient 140 and credential of recipient 140 can be received. Context of recipient 140 can include a geo-fenced location of attempted access, a geo-gridded location of attempted access, a time, a network address, a MAC address, and/or a device network card address and the first credential includes a passcode, a claim id, a shared password, a one-time password, a public key, other secrets, and/or the like.

At 330, access to content 230 can be determined (e.g., by the clearing server). The determining can include comparing terms and conditions 240 to context of recipient 140 and credential of recipient 140. For example, a claim id associated with context of recipient 140 can correspond to a claim id in terms and conditions 240.

At 340, content 230 can be provided to recipient 140. For example, a unit of exchange, an address associated with the unit of exchange, and a private key associated with the unit of exchange can be transmitted to recipient wallet 160.

In some example implementations, the current subject matter can enable the distribution of digital cryptocurrency (“DC”), such as Bitcoin, which can be secured in such a way as to provide for the optional anonymity of both a sender (also referred to as a “Sender of DC”) and a recipient (a “Recipient of DC”) in a DC transaction. In such an approach, the Sender can package associated data representing one or more digital currency units (“DCU”), in addition to the respective credentials associated with the packaged DCU (which can be used to facilitate reassignment of the DCU to an intended Recipient), in an encrypted content holder, referenced herein as a digital currency unit container (“DCUC”). Access to the DCUC can be managed using a clearing mechanism (the “DCUC Clearing Server”) that can be informed by access policies that are specified either before or after packaging the content, such that these policies can be used by the clearing mechanism to approve or deny a request that results in the DCU's assignment to a Recipient. These policies can be created and/or modified by the Sender of DC, an intermediary, and/or other agreed parties after the DCUC has been distributed, without repackaging or redistributing the DC contained in the DCUC. Using techniques that manage the rights and access of Recipients to the DCUC, ultimate Recipients can be known or unknown to the Sender at time of distribution. Similarly, the reassignment can allow the Sender and Recipient to potentially appear as if they are the same party upon review of a broader history of DC transactions. As the DCUC can be demonstrated to be valid and the DC packaged within can be demonstrated as unassigned, a Recipient can participate as an Intermediary and/or provide DCUC to subsequent Recipients without the need for generating broader DC transaction history.

There can be many types of Digital Cryptocurrencies (DCs) and many financial intermediaries (e.g., banks, exchanges, vendors, and/or the like) can be willing to accept the many DC types as payment for service. DCs can be used to facilitate peer-to-peer exchange of currency (e.g., transaction) in online systems. A transaction between DC Senders and Recipients can be facilitated using electronic wallets (referred to as “DC Wallets”). Peer-to-peer exchange of currency (e.g., payment) can use a centralized transaction history for each DC. The central transaction history can provide a clear lineage of the ownership of each Digital Cryptocurrency Unit (DCU).

Replication of this centralized transaction history among many participating nodes can ensure that the ownership of DCUs can be verified from multiple authoritative sources. And that DCUs cannot be used by the same owner for multiple simultaneous transactions. This exhaustive transaction history can ensure that the same DCU cannot be assigned to two different parties simultaneously. Also, transactions in the transaction history can be digitally signed by the DC Sender to ensure the validity of the in the transaction history.

A DCU exchange can include the record of DC transactions. DC transaction records can be stored in a transaction log (e.g., blockchain). The transaction log can hold the records of each DC transaction between different DC addresses (e.g., electronic addresses associated with DC Senders, DC Recipients, and/or the like) with balances that increase and decrease based on, for example, DC sent and received. For example, by adding the amount of DC received and subtracting the amount of DC sent by a DC address on the blockchain, the balance of DC held by any single address can be constructed from the blockchain.

Entries in the blockchain can include the record of a DC address at which the DC Sender received the DC, the amount of DCU that the DC user plans to send to a DC recipient, and the address of the DC Recipient. DCUs can be sent by using the DC Sender's private key to sign a message with the DC Sender's address, the amount being sent, and the DC Recipient's address. By sending this message out to the general DC network, one or more DC miners can verify the transaction, append it to a transaction block (a set of transactions) and write them to the block chain. Whenever a new block of transactions is created, it can be added to the blockchain, creating an increasingly long list of transactions. All DC network participants can receive an updated copy of the blockchain to ensure they have full knowledge of all transaction history.

DC miners can append transaction blocks by calculating one-way cryptographic hashes over the blocks, providing assurance to the DC network of the new transaction block's integrity. Proper ordering of the hash blocks can be ensured by including the hash of the last stored block when calculating the next block's hash. DC miners can be incentivized to calculate these hashes and maintain the blockchain's integrity by receiving a reward. Individual miners and mining pools can compete for these rewards by attempting to be the first to calculate and append the hash for a newly reported block. Hashes can be seeded with a random piece of data that can ensure the proper formatting and complexity of the hash produced, making the hashing process increasingly more complex and the rewards for hashing increasingly more difficult to obtain. These DCUs are then freely available for reassignment among the owners of the mining infrastructure (e.g., DC miners) and subsequent participation in peer-to-peer exchange of DC. Transactions can be verified by miners, and it can take some time to wait before they are finished being appended to the central log. For example, the complexity of mining in the Bitcoin protocol can be set such that each appended block of transactions can take approximately 10 minutes to process. However, in the case of low value transactions, some intermediaries can choose to not wait for verification.

The whole output of a single transaction can be transferred from DC Sender to DC Recipient. However, a partial reassignment can occur (e.g., a Sender can execute a transaction of lesser value by reassigning a transaction record of a higher value) and the Sender can receive a remainder as ‘change’ to a new address.

Transactions can be signed by a DC Sender and can be as secure as the DC Sender's private key. A private key can allow an unauthorized party to reassign DC to keys under the unique control of the unauthorized party. As DC becomes a more conventional store of value and mechanism for payment, theft of private keys can be a risk to DC adoption. To offset the theft of private keys, a variety of wallet types can be used to facilitate transactions, with each attempting to keep private keys of their owners safe. But, all wallets can communicate back to the central transaction log to report change of ownership. When DCUs can be stolen and reused, the transactions associated with these illicit changes of ownership can be logged and visible in centralized DC logs that are replicated for verification in peer-to-peer transactions. Assignments of DC can be irreversible and good actors may return stolen coins. But bad actors, who can believe they are acting with anonymity and impunity can continue transacting with stolen coins while exacting taxes from the initial thief.

Some implementations of the current subject matter can provide mechanisms for specifying, delegating, and enforcing the assignment of DCUs from Senders to Recipients using a trusted intermediary approach and can provide certain guarantees. For example, 1) surety of arms-length transaction; 2) anonymity of Sender relationship with Recipient vis-à-vis centralized transaction chain monitoring; 3) potential for subsequent redistribution of DCUs among intended recipients without subsequent observability; and, 4) anonymity to an intended Recipient, should the DCU be passed through an intermediary. For example, in a DCU exchange, a Sender can present the DCU to an example implementation of the System and receive, in return, a Digital Currency Unit Container (“DCUC”) that may be freely distributed to a Recipient, who at time of receipt adds the DCU to his DC Wallet, as if the Sender was never party to the initial transaction.

A rights managed container can allow the Sender of a DC payment to address a known or unknown Recipient. Rights managed containers can distribute content to end users and control access and activities that can be performed with respect to that content. For example, rights management solutions for distributing music can prevent music that has been serialized to a specific device from being played on another device. For example, rights management solutions for enterprise document management and distribution can ensure than content cannot be viewed, printed, copied, and/or the like without the sender's explicit permission.

A rights managed container can be repurposed to the transfer of DC. The ownership of the DC and its value can become a single portable unit, which can be passed in a controlled manner from Sender to Recipient without specific reliance on centralized audit mechanisms (e.g., central transaction logs) of DC implementations to verify the transfer of ownership and value. For example, a transaction can remain hidden from the centralized transaction log and not mined to the blockchain to be assured of receipt and/or verified as accurate until a time that the DC can be required by the Recipient for a subsequent transaction involving synchronization with the blockchain. Late-bound terms and conditions can be added to rights managed containers. This can allow the use of a Recipient's role and context to determine how and when the DCUC is accessed, such that the DCU associated with the DCUC can be processed by a Recipient's DC Wallet. And, this can add flexibility with respect to the use of DC (e.g., venue, intermediary, and/or the like) and can realize the anonymity of transactions. By packaging the content in a content holder, the secure exchange of credentials can be facilitated and blockchain storage size and computational overhead can be reduced.

The current subject matter can be described in three parts: 1) A Secure Container Structure, the Digital Cryptocurrency Unit Container (“DCUC”); 2) A Mechanism for Flexibly Storing Preferences Regarding DCU Assignment; and 3) Components for the Distributed Packaging, Issuing, Clearing, Accessing, and/or Managing of DC Assignment Transactions.

Some aspects of the current subject matter can include one or more of the following features: a) no requirement that the Sender or Recipient to be known to the system components or to have a direct relationship with each other; b) no requirement for designation of an intended Recipient(s) at the time of DCUC packaging, or established trust to ensure subsequent access and transfer of value from the DCUC package; c) no requirement for centralized management of Sender or Recipient identity, but aspects of identity and identity management may be further introduced to provide additional levels of surety and trust in the communication of DCUs; d) allowance for established transactions involving the use of DCU to be recalled by the Sender at any point prior to the DCU being assigned by the Recipient through a transaction that appends the DC central blockchain; and e) effective creation of a custody state in addition to an assignment state, whereby the full control of the DCU has the potential to be realized by a Recipient, but is pending assignment that is still managed by the Sender.

Some implementations of the current subject matter can include a Digital Cryptocurrency Unit Container (“DCUC”) Structure. Data can be communicated to users of this System and can be stored in secure, rights managed containers. The structure can be specified in a programmatic and/or declarative format. This format can be used by a programmatic subsystem that can encrypt data and can generate a secure Digital Cryptocurrency Unit Container.

A DCUC can be generated by a DCUC Generation Server and can include one or more digital currency content holdings (“DCCH”). During generation of the DCUC, content can be encrypted with explicit terms and conditions for use into specified secure DCCHs. For example, content in a DCCH can include digital cryptocurrency units of exchange; metadata; associated cryptocurrency addresses; private keys; other supporting content for transmission between a Sender and Recipient; and/or the like. Each DCCH can include its own symmetric key to encrypt and/or decrypt its respective content.

Each DCCH symmetric key can be encrypted using the public key of a DCUC Clearing Server. The encrypted DCCH symmetric key can be packaged with the encrypted content. During the clearing process, the DCCH including contents encrypted by the symmetric key and the symmetric key encrypted by the DCUC Clearing Server public key can be sent by the DCUC Recipient using a trusted “Wallet” application to a DCUC Clearing Server. The context and credentials of the Recipient can be used by the DCUC Clearing Server to determine whether the Recipient can be granted access to the DCCH. The decision to grant access to the holding can result in the decryption of the encrypted DCCH content (e.g., holding) using its encased symmetric keys and reencryption with a session specific key negotiated between the Recipient and the DCUC Clearing Server. The session key can permit the Recipient limited use of the holding content (e.g., DCCH content) within a trusted environment, such that they may know the associated Sender wallet and private key to associate with their own use.

One or more DCU can be represented by a single DCUC. For example, if two DCUs are represented by a DCUC, the DCCH associated with each DCU can be independently encrypted. As such, the DCUC can be highly customized for specific applications such as packaging and communication of group payments. And content can be communicated between a trusted Wallet application and the Clearing Server. The DCUC can be delivered using various methods of distribution (e.g.; email, Internet, private network, portable device, removable storage, etc.) without breaking the underlying security model and/or model guarantees.

In some implementations, securing DC can be tamper-resistant, and, depending on key strengths used for encryption, can be tamper proof. The DCUC format can be structured such that: various types of pluggable encryption algorithms can be used to secure DCU addresses and private keys; industry standard credentialing and public key infrastructure (PKI) technology validates DCUC Recipients such that they can extract or add associated DC private keys to their personal wallets; digital signatures and message digests over encrypted DCCH may assure end users that content can be genuine and has not been tampered with; and/or packaged content can be validated and presented as authentic at the time when the DCUC can be opened at the trusted Wallet.

In a digital cryptocurrency application, for example, metadata within a DCUC can provide a structure such that the DCUC can be searched without compromising the safety of the address and/or public key in a transaction. Additional metadata can be added to enhance processing capabilities at the time of clearing. No indication can need to be made to the DC's blockchain that the DCU has been packaged or can be distributed in the DCUC format. The DCU can appear to be held in place.

To build a DCUC, a DCUC Generation Server can use specification data included in a Rights Management Specification. The specification can include information that can specify a relevant DCUC Clearing Server to the Recipient Wallet. And, the specification can specify the roles and credentials that are eligible for requesting content access.

Packaging metadata, including that regarding the DCUC Issuer (e.g., builder) and general identification numbers can be included in the payload used for clearing the document such that it can be used in determining user specified restrictions over the content that can be excluded from embedding in the terms and conditions of a requested holding. Requests for access to a DCUC's DCCH can be configurable and can be logged at the DCUC Clearing Server to facilitate account auditing and reporting. Where transactions are anonymized with respect to Sender and/or Recipient, auditing can reflect the attempts to assign the DCU and the final clearing that permits the assignment. Once a DCCH's DCU has been assigned, the DCCH can be ineligible for subsequent clearing. In an event that subsequent clearing can be permitted through application defect or malicious user engineering, the DC central transaction log can be used to verify the legitimate owner of the DCU. The DCUC Clearing Server can reference the DC blockchain as a step in ensuring that the represented DCU is not being double-spent as it's reissued as a DCUC by the System.

Some implementations of the current subject matter can include a Mechanism for Flexibly Storing Preferences Regarding DCU Assignment. The mechanism can used for storing and identifying Sender preferences regarding content access and can be defined by three different semantic structures: Articulation of Digital Currency Unit Container (DCUC) Structure; Articulation of the DCUC Sender relationship to Recipients (if applicable); Articulation of the DCUC Sender preferences.

Some implementations of the current subject matter can include Articulation of Digital Currency Unit Container (DCUC) Structure. Packaging descriptions for the DCUC can be used by the System to keep track of the DCUC issued and its supporting structure. This DCUC structure is specified in terms of: Digital Cryptocurrency Unit Container (DCUC); Digital Cryptocurrency Unit (DCU); and Digital Cryptocurrency Content Holdings (DCCH).

A Digital Cryptocurrency Unit Container (DCUC) consistent with implementations of the current subject matter can include a structure consistent with the descriptions herein. It can be referred to by one or more of the following: a unique name, a unique generated identifier, a DCUC Issuer (e.g., DCUC Generation Server), and, alternatively, in a non-anonymous distribution scenario, the DCUC Sender. The generated identifier, which can be non-sequential, can be used for the purpose of cataloging, management, control, and/or audit by the System.

The System can be specified as the DCUC Issuer for purposes of aggregating or publishing the DCUC to intended Recipients for further distribution and use. DCUC metadata can provide information about the aggregate value/s and DC type/s of DCUs stored in the DCUC, such that the value of the DCUC can be ascertained without live connection to the DCUC Clearing Server. The DCUC can store information regarding one or more DCUC Clearing Server or Clearing Server networks where its content can be decrypted. In cases where the DCUC metadata does not contain this information, the information can be bound to the description of the DCUC holding to which access can be requested and/or as part of the encrypted content of the DCUC holding. A Recipient can provide context and/or credentials required to decrypt the type and amount information as part of the DCCH, independently and/or as part of their request to access the DCU related content.

The DCUC can allow for release and/or delivery of metadata related to the DC, while keeping the necessary private key for assignment under conditional access with conditions specified by the Sender. The DCUC can only hold private keys necessary for reassigning publicly available DC, DCs communicated in another fashion, and/or DCs in a separate DCUC. A benefit of this can include that the DCUC (e.g., coin) could be released to an intended Recipient and the keys can be issued contingent on subsequent agreement, activity, and/or other conditions.

Some implementations of the current subject matter can also provide for DCUC Security. The DCUC can include a self-contained container (e.g., a DCCH) including a digital cryptocurrency. Within the DCUC, the private key used to assign the DC and other related assignment components can be stored and encrypted using one-time generated symmetric keys, which can be encrypted using a public key that corresponds to a private key on the Clearing Server key ring. As a result, the contents of the DCUC can be compound encrypted. The metadata can be alternately encrypted, but it can be assumed that the face of the container, absent the sender and/or recipient information cannot effect anonymity of the Sender and/or Recipient.

DCUC Deterrence can be include an advantage provided by the current subject matter. Given enough incentive, an attacker can attempt to decrypt the DCUC via brute force to obtain the private key and subsequently use the retrieved private key to append the retrieved currency to the wallet. However this can be an issue if 1) the cryptocurrency has not already been assigned to a user wallet (e.g., the central blockchain for the currency has not been updated), and/or 2) the user who hacks the currency needs to maintain anonymity within the closed system. If an unintended recipient retrieves the currency in the closed system, recipients of the hacked currency can be tracked using the blockchain. A conditional policy can be enforced whereby recipients of currency received as a result of a hacked DCUC must reassign their currency back to the Clearing Server or the last known party prior to packaging. This conditional policy can resolve the issue of stolen cryptocurrency.

A Digital Cryptocurrency Unit (DCU) can include the private information required to be shared with an intended recipient to effect a transfer of DC ownership. This can include the private key associated with the DC being exchanged, the associated address, and/or the amount intended for transfer, but can also include additional trusted metadata used in the exchange that can only be accessed by the DCU recipient. In some implementations, this information can be captured in an extensible markup language (XML) or javascript object notation (JSON) structured content format, but can as easily be incorporated using a request for comments (RFC) 822 file format or other structured/unstructured data approach, for incorporation into the DCUC.

Digital Cryptocurrency Content Holdings (DCCH) can be uniquely encrypted collections of content and associated terms and conditions stored in the aggregate form of a DCUC. A DCCH can hold one or more pieces of content that are released to the control of Trusted Client Wallet. An authorized request to the Clearing Server can allow for the decryption of a DCU's associated private key. DCCHs can be considered authorized for access by parties other than a Recipient who meets the Sender's criteria for DCU assignment, but in these cases, the Private Key can be made not available for decryption. This can be performed by mirroring the private key holding with a holding that only includes metadata content.

Articulation of DCUC Sender's Relationship to Recipient can be included in some implementations of the current subject matter. The System can differ from rights management systems in that it can be deployed in fully trusted environments, where both the Senders and the Recipients of DCUCs can have known and verifiable identities. Implementations of the current subject matter can also be operated where Senders and/or Recipients of DCUCs are unknown to the System or each other, and where knowledge of either Sender and/or Recipient identity is asymmetric (e.g. Sender identifiable to system or Recipient identifiable to system).

While the System cannot require the centralized management of Sender and/or Recipient identity, aspects of identity and identity management can be layered into the system to provide additional levels of surety and trust in the communication of DCUs. When working with Senders of DCUs, for example, nothing about the Sender need be established with respect to their identity. An account with a traditional username, password, and/or other credentials can be completely optional for the System to work.

In some implementations, the Sender can submit the amount of the DCU to the System, along with the private key associated with the DCU address and can receive a system generated identifier. This identifier can be used to subsequently manage the DCUC that has been created. At a level of additional certainty, the generated identifier can be used in conjunction with an established set of non-specific user identifiers, including computer IP or MAC address, sending device geolocation, and/or time of day to determine control parameters over the distributed DCUC. With specific user credentials, including usernames and passwords, or email addresses added to the System, it can be possible to allow for extensive user focused management of DCUC generated by the Sender, in addition to recovery of generated DCUC identifiers.

A Recipient looking to receive access can be not explicitly known to the System to access the content of the DCUC. Upon receiving the DCUC, the DC Recipient's Trusted Wallet can connect with the System and provide user context, application context, and/or data context (e.g., information about the DCUC being opened). If the criteria for accessing the DCUC are non-specific to Recipient and criteria for releasing the content of the DCUC have been satisfied by application context and non-specific parameters (e.g., a potential passcode/claim id, geo-fenced or geo-gridded location of attempted access, and/or the like) then the Recipient can effectively claim the DCU without being known to the Sender. An implication of this approach is that a DCUC can be given to multiple parties, each of whom can verify that the DCUC has not been spent. Upon an agreed condition, the Sender may enable the DCUC for one Recipient while disabling the distributed DC in possession of the others. Because multiple DCUCs can be freely distributed (even to a public directory) it can be impossible to identify the intended Recipient until the point where they add the key to a wallet.

In cases where the Recipient is not concerned regarding their use of the System, it plausible that the Recipient's account (e.g., within the System) can be used as a public facing address. Any Sender, known or unknown to the System can potentially use that address for transmitting cryptocurrency. Within the System the criteria for approval of Recipient access can be expressed in a single table structure that can reference a record of the Recipient as an identified user in the system. The table can relate the system identifier of the DCUC; an identifier of the DCCH; the contextual access type that is enabled (e.g.: LOCATION, TIME, PASSCODE and/or the like); the qualified parameter by which the rule is established as true (e.g. BEFORE, AFTER, EQUALS, WITHIN and/or the like); the value of the parameter for testing qualification (e.g. 10 am, Pym, “secret”, 10 miles of latitude/longitude and/or the like); whether it is qualified as a AND or an OR condition; and if it is grouped in evaluation with other rules expressed. Multiple rules on a holding's access can be considered additive by a logical AND operation, unless otherwise specified. In some implementations, basic expressions can be structured for processing, for example, allowing concepts such as the following to be expressed:

(RULE 1 && RULE 2 && RULE 3)∥RULE 4

(RULE 1 && RULE 2) && (RULE 3∥RULE 4)

(RULE 1 && RULE 2)∥(RULE 3 && RULE 4)

In a case in which the Sender and Recipient are Known To System, all eligible Senders and Recipients can have an account with the System, where they have been credentialed such that they can be authorized to access the system (e.g.: using passwords, PKI, One-time-password, and/or the like). Senders can invite Recipients to use the system using conventionally accepted mechanisms. Sender and Recipient credentials can be stored in either a data store repository (e.g.: relational database, non-relational databases, NoSQL data store, and/or the like), a lightweight directory (e.g. lightweight directory access protocol), and/or the like a flat file.

Senders can identify intended Recipients for DCU payments from a common directory and specify additional conditions (e.g., a shared password, location for retrieval, time and/or date for retrieval, other conditions that should be used in consideration by the System, and/or the like) in considering the transfer of the DCU to the intended Recipient.

The Recipient can be notified of DCUC creation. The Recipient can, for example, receive the DCUC as a common attachment to an email communication from the System. The Recipient can receive an invitation to retrieve the DCUC from a private retrieval area of the System, such as a private messaging system, ‘Inbox’, and/or the like. The Sender can retrieve the DCUC from the System and provide the DCUC to the Recipient as an attachment to email, on removable medium, on publically hosted file sharing site, and/or the like.

The Sender can track the successful receipt of the DCUC and opening of the DCUC. The System can additionally poll the DC's central transaction log for confirmation of reassignment of the DCU to the intended Recipient.

In a case in which both of the Sender and Recipient can be Unknown to the System, a deployment can be advertisement sponsored, otherwise supported within a closed community, and/or the like. Prior to interacting with the System, the Sender can choose to create a new DC Address and Private Key for the value of the DCU being exchanged. The Sender can submit the Address and Private Key to the System and can specify conditions under which the DCUC can be opened. The resulting DCUC can be packaged and returned to the Sender along with a unique identifier that can be used to track the DCUC at the System. The Sender can be responsible for distributing the DCUC to any Recipient. Only a Recipient capable of presenting the criteria used for packaging the DCUC can retrieve the DCU stored within. As multiple DCUs can be within the same DCUC, each DCU can use the same or different criteria such that one or multiple Recipients can access and reassign the DCU to their private wallet.

Criteria used for each DCU can be specified at the level of the DCUC holding, (e.g., DCCH). The criteria used in clearing a DCCH can include location (latitude/longitude, geo-fence, geo-grid, and/or the like), time of day, network address, device network card address, shared password, other secrets, and/or the like.

If only the Sender is Unknown to the System, a transaction can proceed as discussed above, with the exception that the Sender can identify one or more intended credentialed recipients and can use those credentials explicitly in specifying the conditions under which the Clearing Server can provide access to the DCCH.

If only the Recipient is Unknown To System, a transaction can proceed as discussed above, with the exception that the Sender can be unable to identify one or more intended credentialed recipients and use the above mentioned methods of authorization, including, for example, geolocation characteristics, shared keys, and/or the like.

Articulation of DCUC Sender's Use of an Intermediary can also be supported. In each scenario of known or unknown identity, the System can be responsible for publishing content on behalf of the Sender and the DCUC Clearing Server activity can be coordinated with Sender specifications for access to DCUC holdings. As such, content access policies can be deterministically applicable given a request to access the content. The Sender and the Recipient need not have a dynamic link that can establish a fixed relationship for the System to associate the end-user performing a DCUC access request with the Sender of the DCUC in the System's clearing mechanism.

Assuming a requirement for an intermediary to work on behalf of the Sender to refine criteria or specifically permit access to a DCCH of a DCUC, it can be possible for such a party to do so by, in the case of a known Sender, allowing the Sender to delegate authority to another identified user of the System. In the case of an unknown Sender, the intermediary can use the unique tracking identifier provided to the Sender at the time of DCUC Generation. The identifier can be exchanged between Sender and Sender Intermediary.

Processing a request to the Holding of a DCUC can occur as follows. The System can service Recipients with credentials identified by the System and/or Recipients who are not identified using specific credentials.

Processing a Request to the Holding of a DCUC from an Identified Recipient can include the following. When the System's DCUC Clearing Server mechanism services a request, the Recipient's credentials can be resolved to a user reference in the System, while the DCUC metadata submitted with the encrypted DCUC holding can be used to identify the DCUC reference and the conditions for access that have been specified by the Sender. Matching for an association between a DCUC recipient and DCUC for the purpose of unlocking the contents of a DCUC holding can proceed in the following manner. A specific relationship between the DCUC can be sought, whereby the Sender (if identifiable to the System) of the DCUC can be referenced in assisting the processing. On condition of an explicit relationship between the requester and conditions by which the Sender specified access to the container, the DCUC Clearing Server mechanism can return authorization for the content to be unlocked. On condition for access having been met, the DCUC Clearing Server mechanism can return authorization for the content to be unlocked.

Processing a Request to the Holding of a DCUC from an Unidentified Recipient can occur such that when the DCUC Clearing Server mechanism services a request, the user credentials cannot be available for presentation. The clearing mechanism can communicate back to the trusted wallet, upon identification of a clearing condition specifying a shared secret (e.g.: a password, and/or the like), and the Wallet can prompt the user to supply additional information for the purpose of clearing. For example, application context, including location of the Recipient's originating transaction can be sent to the clearing mechanism. If an explicit condition can be detected by which clearing can occur, the mechanism can provide authorization for the request to result in the content being unlocked.

A Sender can disable the DCUC or Relationship with an identified Recipient. For example, if the DCUC becomes compromised, lost, stolen, and/or the like, the DCUC can be disabled by the Sender or an intermediary knowing the unique identifier provided at the time of generation. All requests to a disabled DCUC can be traced to origin for subsequent audit. The DCU can be not compromised or capable of being subsequently accessed. In the case of a Recipient that has been identified explicitly, a Sender can disable DCUCs they issue with respect to that Recipient specifically, pending reactivation of the relationship, without generally disabling DCUCs that can be in their possession.

Some implementations of the System can provide the Sender of a DCUC the ability to specify conditions under which the DCUC can be accessed (e.g., to articulate DCUC sender preferences). These preferences can serve as a default for all DCUCs generated on that identified Sender's behalf. For example, preferences can include requests for email notification, the ability to dynamically authorize the request for access to content in cases where the Recipient cannot be explicitly identifiable by predetermined specification of the DCUC or the System, and/or the like.

Both Identified and Unidentified Senders can have the ability to specify terms for the intended Recipient, for example, characteristics of user's credentials; if the Recipient is known to the System or Sender, the location of the recipient (e.g.: by specifying an address, latitude/longitude, geo-grid, geo-fence, and/or the like); the time at which the Recipient can access the DCU from the DCUC; a shared secret (e.g.: a password); other criteria for which the deployed System has been customized; and/or the like.

Components for the Distributed Packaging, Issuing, Clearing, Accessing, and Managing DC Assignment Transactions (e.g. operational components of a system) can include a DCUC Generation Server/Issuing Server, a DCUC Clearing Server, a DCUC Trusted Wallet, and a DCUC Management Environment

Independent of the components of this system, in some implementations, the System can rely on a system of network traffic proxies, VPNs, open solutions such as TOR (the Onion Router) to anonymize network activity of DC Senders and Recipients from external observation. The solution can also rely on a system of intrusion detection devices and active monitoring devices for the purpose of securing the internal network operations, components around core components of the System, and/or the like.

As discussed above, control of content access can be specified either statically and/or dynamically. Some implementations of the System can decouple the specification of Sender preferences, end-user credentials, encrypted content, and/or the like, such that they can be used dynamically and flexibly in runtime to enforce access privileges specified by DC Senders with respect to the criteria for receipt of DCUs.

Some implementations of the System can make use of network and data level security, such as implementations of Public Key infrastructure and/or key exchange, to prevent message interception and/or fraud. Components can be authorized using public key signatures and communication of services can occur using encrypted data wrapped by SSL protocol. In the case of the Trusted Wallet, code-signing techniques can be used to ensure that the user-facing client to the sending and receipt of DCUC cannot be tampered with at an endpoint and/or to provide an end user opportunity to manipulate the system.

The DCUC can be built by a DCUC Generation Server that can have an address and one or more Public Keys of one or more DCUC Clearing Servers to process a DCUC access request made by a DCUC Recipient. The DCUC Clearing Server can possess one or more Public Keys associated with one or more DCUC Generation Servers, so as to determine if components of a DCUC requested for access have not been tampered with. As such, the DCUC Issuing Authority and DCUC Clearing Server can be decoupled components of the System that can be hosted by different entities. The holdings of a DCUC can be resolved at different DCUC Clearing Servers. Similarly, a DCUC Clearing Server can be configured to clear DCUs originating from one or more DCUC Generation Server.

Trust between components can facilitate operation of the System. Keys exchanged between components can be trusted because they can be issued by the same Certificate Authority and/or other mechanisms by which trust in key exchange can be maintained (e.g. using trusted third parties, public certificate authorities, and/or the like).

DCUC Generation Server/Issuing Server features can include one or more of the following. Some implementations of the System can use a mechanism for packaging referred to as the DCUC Generation Server. The party packaging the DCUC can ensure that each private key added to the DCUC represents the ownership of a DC public address having the full balance intended for transfer. A DC Sender can make a payment to themselves using conventional DC Wallet client whereby they can create a specific address having the balance amount of the DCU transfer to be performed. For the purpose of assigning a DCUC with as little history as possible, the Sender can use a new address and private key when acquiring the DCU intended for transmission to a Recipient.

The Sender can use the Trusted Wallet to facilitate ease of this type of manipulation and amount assignment. As the mechanism for DCU transfer can include Sender to Recipient private key and address (e.g., full identity) transfer with respect to the DCU being communicated, in some implementations of the System (e.g. one where the System does not write transactions to the DC blockchain), DCU amounts can be exact (e.g., no change from the transaction can be generated without compromising either the System's, the Sender's, and/or the Recipient's anonymity with respect to the DC exchange). The transaction change can be settled between Sender and Recipient using fiat currency, and can imply a trusted relationship between both parties to ensure the fiat settlement occurs. The System can provide management tools to keep running transaction change balances between Senders and Recipients and can facilitate settlement.

In some cases, a DCUC can be packaged by an intermediary and the intermediary can package DCUs from multiple Senders, as long as the Intermediary can be trusted with those Sender's public addresses and private keys. In this case, the intermediary can be known as a Sender Intermediary. The resulting DCUC can contain multiple DCCHs and each DCCH can reference a private key of multiple independent senders. Where a recipient of the DCUC cannot be the immediate Recipient, but can be responsible for the retransmission and/or alternative movement (e.g., via removable storage, USB drive, and/or the like) to an intended recipient, this party can be called a Recipient Intermediary. A single Sender can similarly package multiple DCUs having different intended Recipients within the same DCUC.

Packaged DCUCs can have unique identifiers that can allow them to be tracked, logged, audited, and/or the like by the System.

In cases where the deployment of the System can be known, a transaction splitting activity can be performed at the System and/or at the DCUC Generation Server for a nominal fee. The collection process for the fee can be recorded to the DC centralized transaction log. In this case, the Sender can maintain the private key associated with the DCU and a new address and private key can be created by the System for the purpose of facilitating the transaction for the Recipient.

In some implementations, the DCUC Generation Server can verify the known status of addresses presented for inclusion in the DCUC to ensure available balance and authoritative ownership of the DC Sender. It can test the wallet address/private key pair submitted to ensure they are properly associated with one another. At the time of packaging, the user can either provide the key pair used for receiving the DC or can assign the DC to a temporary address. In the case of the temporary address, the DCUC Generation Server can be the owner of the private key and address for the assignment, but both keys can be stored in the DCUC and not kept with the System or maintained at the DCUC Generation Server.

In some implementations, the System can be identified to the DC blockchain as a known central intermediary. In this case, the public blockchain can show the assignment to and/or from the intermediary, and can invalidate the anonymity of the Sender and the Recipient as being the same party. Of course, if the final Recipient cannot be the initial receiving Recipient of the DCU, the origin as having come through the intermediary can be unknown. In the case of uncredentialed use, shared secrets can be used to unlock and assign the DCU. Ultimately, the blockchain can be the arbiter of whether there has been a breach or attempt to reuse the private key associated with a DCU.

Using the DCUC format and the structures discussed above, the System can facilitate authorization to rights managed content by, for example: 1) Considering the presented credentials to identify the Recipient; and 2) Using presented credentials to identify preferences that can exist for that Recipient's behavior in the system through a directly articulated relationship with the DCUC specified by the Sender, or, in the case of a Recipient who does not have credentials, through alternative parameters that have been submitted as part of the Recipient's request context in session with a DCUC Clearing Server.

Using this mechanism, a Recipient user can be either authorized to access content on the basis of either explicit permission by the Sender or through the fulfillment of authorization criteria established for the DCUC at the time it was issued.

The DCUC Clearing Server can use a plurality of private/public keys for the purpose of issuing different vintages or strengths of DCUC. These keys can be randomly or specifically assigned for use during the DCUC Generation Server process, and/or on the basis of required strength or surety. In cases of the highest surety, the DCUC Clearing Server can use paper keys and facilitate clearing in an offline/human enabled process. Keys used by the DCUC Clearing Server can be stored using a hardware cryptographic system, in a computer file system, on network, in memory, and/or the like.

The DCUC Clearing Server can be further characterized by integrated messaging and notification systems, such that access requests can be communicated via an online message center, email, short message service (SMS), interactive voice response system, other modes of end user communication, and/or the like. This integration can allow for ambiguous requests from potential recipients to be vetted and authorized by a potential Sender in real-time, should the requirements for facilitating this communication be met by the Sender in either an identified or unidentifiable context. For example, a Sender with an account with the System can have an email address and/or a mobile phone number on record to permit this activity, whereas an anonymous user with the system can provide a phone number and/or email address at the time of DCUC packaging to facilitate interactivity at the time of clearing. A Sender can have preference for how they are contacted and/or can choose different mobile phone numbers and/or email addresses depending on the DCUC being accessed, the holding of the DCUC being accessed, the Recipient requesting access, and/or the like.

The DCUC Clearing Server can log transaction history of each DCUC with varying levels of granularity. In cases where an issued DCUC can be unlogged, this preference can be specified by the sender, irrevocably, and/or turned on/off by the Sender and/or their Intermediary as part of their control settings over the DCUC. Transaction logging can be configurable at the DCCH level.

The DCUC Clearing Server deployment can keep a mandatory activity log, in which case Sender flexibility in enabling or disabling these options can be limited.

The DCUC Clearing Server can be seated behind an obfuscated address and/or on a different network from standard DC activity. The DCUC Trusted Wallet can interact with both the DCUC Clearing Server and the DC network, although additional processing features added to the DCUC Clearing Server can allow direct interaction between the DCUC Clearing Server and the DC network. The DCUC Clearing Server can be known to the DCUC Generation Server and specified at the time of packaging, and can be hosted in an environment that can be trusted by the DC Sender.

Following a successfully cleared conveyance between a Sender and Recipient, the DCUC Clearing Server can immediately disable all requests from DCUCs having the same id as one that has already been successfully cleared. Similarly, at the time of clearing, the DCUC Clearing Server and/or the Trusted Wallet can observe the blockchain for the DCUC to ensure that the DCU cannot have been spent using conventional mechanisms prior to being reassigned to the wallet. This can provide assurance that once assigned, all other copies of a DCUC containing reference to the same DCU will fail to clear, and can allow DCUCs to be anonymously distributed and/or super-distributed with a level of trust independent of registration provided by the blockchain. For example, a Sender can pay someone using a DCUC through an intermediary, whereby neither the Sender nor the intermediary can be known to the Recipient, even though ultimate control over the assignment of the DCU can still be determined by either the Sender and/or any other third party given ability to set access parameters at the DCUC Clearing Server.

In normal use the high level clearing process can include the following operations. 1) The client DCUC Trusted Wallet presents information about itself and the Recipient's context, demonstrating that the client DCUC Trusted Wallet has not been tampered with and can be a valid application for participating in a Trusted Wallet transaction. If it is determined the Trusted Wallet connection can be safe for communication, the DCUC Clearing Server can negotiate a session key for the communication of secured data. 2) The Recipient DCUC Trusted Wallet can send the encrypted DCCH, application context (e.g.: computer location, and/or the like), and Recipient credentials (e.g. user credentials, pre-established clearing password, and/or the like) to the DCUC Clearing Server where the credentials can be verified and on the basis of articulated application logic, the contents of the DCCH can be either a) decrypted and encrypted for communication back to the Recipient using the negotiated session keys, providing restricted assignment of the DCCH within the scope of the DCUC Trusted Client's session with the DCUC Clearing Server; or, b) not decrypted and the Recipient wallet is notified of failure of the decryption process on the basis of either poor credentials, unverifiable digital signature on the encrypted content holding, or application logic provided for controlling/overriding DCUC Clearing Server processing behavior. 3) If decrypted for the Recipient, the DCUC Clearing Server can be assured that the Trusted Wallet has full control over how the Recipient manipulates the data retrieved, such that it cannot be further redistributed without the protections and audit provided by the DCUC.

DCUC Transaction Safety for Sender and Recipient can also be provide by implementations of the current subject matter. The DCU can remain unassigned until the DCUC Trusted Wallet can be used to successfully retrieve a DCU from the DCUC and the corresponding DC blockchain can be updated with the new custody address. As such, the sender of a DCUC can cancel the distribution of a DCUC at any point and reclaim the currency by opening the DCUC in their own wallet under the clearing conditions. In some implementations, the System can manage grievances associated with such issues between Sender and Recipient by annexing and/or reassigning DCU from other transactions.

A Multi-tiered Clearing Mechanism can preserve the anonymity of Sender and Recipient. The DCUC Clearing Server can act as a proxy for approval logic hosted by another party capable of identifying the intended Recipient on the basis of credentials, context (e.g.: location, time of day, and/or the like), and/or other information submitted at the time the request to clear the DCCH can be issued. In this case, the DCUC Clearing Server receiving the request can be provided with information and configured such that it can be capable of forwarding the request it receives to another DCUC Clearing Server and/or alternative service trusted for processing similar Recipient requests. Such forwarded requests can occur over a network used for server-to-server communication. This communication can happen as a Service-oriented request (e.g., simple object access protocol (SOAP), representational state transfer (REST), by remote application programming interface (API), procedure call, and/or the like). In some implementations, service requests can occur over a transmission control protocol (TCP) and/or internet protocol (IP) network and can use a REST-based API set of calls via hypertext transfer protocol secure (HTTPS), such as for secure communication over a computer network.

An example advantage of this approach can be, while a Recipient can be unknown to a DCUC Clearing Server used for issuing the DCUC, credentials and/or context presented by the Recipient can be cleared at an alternative location, and can allow the DCU to be similarly reassigned without the custodian of the primary DCUC Clearing Server having full understanding of the determination logic being used for processing. Messages passed between two DCUC Clearing Servers or a DCUC Clearing Server and an Authorizing service can be secured using Public Key cryptographic techniques, where public keys can be exchanged and trust necessary for authoritative determination of message content can be established.

Support for Verification Requests can be provided. The DCUC Clearing Server can provide an interface to support verification requests, whereby anyone in possession of a DCUC can verify that the DCUC is authentic and signatures from the DCUC Generation Server can indicate that the DCUC cannot have been tampered with from the time of original issuance. The DCUC Trusted Wallet can communicate context necessary for the DCUC Clearing Server to perform its functions, and other software offerings and/or components can similarly be developed and trusted by the DCUC Clearing Server as envisioned.

The DCUC Clearing Server can remain unaware of the identity of the party attempting to clear, meaning that the DCUC can be presented using context, such as an agreed upon geography, password that can be used to determine authorization, and/or the like. The Trusted Wallet can provide support for the trusted communication of this context back to the DCUC Clearing Server, in a way that the DCUC Clearing Server can identify that the data cannot have been tampered with. In other cases, credentialed Recipients can clear using biometric credentials that can be collected by the DCUC Trusted Wallet and transmitted back to the DCUC Clearing Server. Time delays over redemption and/or the application of context can also be used. This can include a time server. DCUC Trusted Wallet requests can be geo-fenced and/or geo-gridded to allow for tolerance of requests, such that requests can be restricted to specific geographies. DCUC Trusted Wallet requests can be restricted by requesting device network MAC address and/or other identifying criteria. In cases where the intended recipient can be more specifically known, the credentials can include two factor authentication and/or one time passwords, coordinated using a soft token, hard token, mobile device, and/or the like.

The DCUC Trusted Wallet can provide the Sender and Receiver with an easy-to-use mechanism for providing interaction with the System. For the sender it can provide: an easy point of management from which to submit DCU information to the System for processing; an interface to manage the status of DCUCs that are pending access by Recipients; an interface to allow for contextual approval of Recipient requests, allowing for interactivity between the Sender and the DCUC Clearing Server.

For the Recipient it can provide: a point of interaction to claim pending DCUCs and assign them to the Recipient's ownership; a basic security footprint that ensures only trusted interaction with the DCUC Clearing Server, whereby user credentials, context, and other information can be used to support authorization and access to a received DCU.

The Trusted Wallet mechanism can be packaged with registry detection or other service verification to ensure the system is clean of spyware or viruses prior to allowing for the opening of a DCUC. It can provide a safe sandbox for managing Wallet activities, preventing screen capture from spyware, where typically spyware and malware on DC Recipient computers can sniff credentials and retrieve private keys. It can communicate the assignment of the DCU to the DC central transaction log from within one application, such that the blockchain can be updated with the new DCU assignment.

The DCUC Management Environment can include a set of deployed services that can be accessed by either desktop or mobile device, but similarly has potential to work with interactive voice response (IVR) and/or other technology interfaces to provide tooling necessary for the Sending, Receipt, Management, and Control of DCUC transactions. The DCUC Management Environment can be deployed by itself and/or with the whole System. In singular deployment it can connect with the hosted components of other DCUC Generation and Clearing environments.

In some implementations, roles supported by the DCUC Environment interface can include: DC Sender—A party using the System to distribute DC in the DCUC format; and DC Recipient—A party using the System to receive DC in the DCUC format. Other roles can be easily be added to the system, such that only certain functions of the DCUC System are exposed for conventional use.

In some implementations, features of the system can include an internal notification and messaging system for securely notifying credentialed Senders and Receivers of active/pending/completed/suspended/rejected DCUC transactions, including those generated as a result of the DCUC Generation Server or DCUC Clearing Server activity. In some implementations, features of the system can include a DCU submission system for providing workflow to enable DC Senders to send DCUs to either specified or unspecified recipients, including the ability to: specify a public DC Address and upload a corresponding Private Key for the Address submitted; specify the format of DC and amount of the DC being exchanged; add/remove additional DCU to the same DCUC that is pending construction; search identifiable Recipients from a public directory hosted by the System; specify Recipients using an address associated with their account that is hosted by the System; specify qualifying criteria that an intended Recipient must meet prior to receiving access, including a location from where the intended Recipient may claim the DCU packaged in the DCUC, times/dates when a request may be considered acceptable, shared secrets (e.g.: commonly known passwords to facilitate DCU retrieval, or the desire for interactive notification and approval of a DCU access request; specify levels of transaction monitoring and logging for issued DCUCs; see and monitor access to issued DCUCs, and render them or relationships with intended recipients inactive.

The DCUC Management Environment can include a high-assurance web based environment that is segregated into tiers for processing, but also flexible hosting should a public-facing implementation be required. Callbacks to other components can be performed using a secure servicer-oriented architecture. The DCUC Management Environment can be stateless and can be scaled across multiple servers for ease of meeting performance goals.

Although a few variations have been described in detail above, other modifications or additions are possible. For example, some implementations of the current subject matter can include mobile environments and/or devices, web environments and/or devices, and/or combinations thereof. For example, a secure rights managed container can include multiple content holders. Each content holder can include a different set of credentials than the other content holders including different terms and conditions and a different context for providing access to the content in the content holder.

Custody of credentials included in each content holder can be coordinated, for example, by the clearing server and credentials (e.g., keys, terms and conditions, context, and/or the like) can be identified in place. And custody can be included in a state channel between the clearing server and a client during session activity. This can facilitate parties authorized to access the content in the content holder to perform modifications to the content and ensure that the modifications to the content, and the clearing server can validate the modifications to the content. For example, the clearing server can verify that content was signed, and that a credential included in the content holder can be active. And the modification to the content can be included in a pending active stack while waiting for the session between the client and the clearing server to be closed. This can prevent unauthorized and/or unverified modifications and/or partial use of content.

In some implementations, proxy based encryption (e.g., proxy reencryption schemes) can be utilized between a client and the clearing server. This can ensure, for example, the content in the content holder can be encrypted by the Sender and for the Recipient without a third party, such as the clearing server, receiving access the unencrypted content in a content holder. For example, the Sender can encrypt the content in the content holder and provide a reencryption key to the clearing server. The clearing server can reencrypt the content in the content holder using the reencryption key and provide the reencrypted content to the recipient. The recipient can then decrypt the reencrypted content. For example, the Sender can encrypt multiple content holders that can be intended for multiple Recipients and provide multiple reencryption keys, with each key corresponding to a respective intended Recipient. The clearing server can reencrypt each content holding using the reencryption key of the intended Recipient. Each intended Recipient can then decrypt the content in their respective content holding.

The subject matter described herein provides many technical advantages. For example, digital cryptocurrency can be exchanged between a sender and a recipient without waiting for a blockchain block update and/or confirmation. Conventionally, an exchange requires a wait time of around ten minutes before validation. Some implementations of the current subject matter can facilitate substantially quicker validation of digital cryptocurrency exchanged between sender and recipient by utilizing secure rights managed containers. By utilizing secure rights managed containers, redundant modifications to the blockchain can be avoided, and the cost associated with storage and computation of the blockchain can be reduced.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing a secure rights managed container including a first content holder, the first content holder including a first content, first terms and conditions, and a symmetric key, the first content encrypted by the symmetric key and configured to enable a modification of a blockchain, the first terms and conditions specifying access to the first content, and the symmetric key encrypted by a public key of a clearing server;
receiving a first context of a recipient and a first credential of the recipient;
determining, by the clearing server, access to the first content by the recipient at least by comparing the first terms and conditions to the first context and the first credential; and
providing the first content to the recipient for executing the modification of the blockchain.

2. The method of claim 1, wherein the providing further comprises:
decrypting, by the clearing server and using a private key of the clearing server, the symmetric key;
decrypting, by the clearing server and using the decrypted symmetric key, the first content; and
providing the decrypted first content to the recipient.

3. The method of claim 1, wherein the providing further comprises:
generating, by the clearing server, a session key between the recipient and the clearing server;
encrypting, by the clearing server and using the session key, the first content; and
providing the encrypted first content to the recipient.

4. The method of claim 1, further comprising:
receiving data characterizing the first content and the first terms and conditions;
generating, by a generation server, the symmetric key;
encrypting, by the generation server, the first content;
encrypting, by the generation server and using the public key of the clearing server, the symmetric key;
packaging, by the generation server, the encrypted first content, the first terms and conditions, and the encrypted symmetric key into the first content holder; and
providing the secure rights managed container including the first content holder.

5. The method of claim 1, further comprising:
executing the modification of the blockchain.

6. The method of claim 1, wherein the first content includes a first digital cryptocurrency unit of exchange, metadata, a first cryptocurrency address associated with the first digital cryptocurrency unit of exchange, a first private key associated with the first digital cryptocurrency unit of exchange, and/or supporting content for transmission between a sender and the recipient.

7. The method of claim 1, wherein the first terms and conditions include a passcode, a claim id, a geo-fenced location of attempted access, a geo-gridded location of attempted access, a time, a network address, a device network card address, a MAC address, a shared password, and/or other secrets.

8. The method of claim 1, wherein the first context includes a geo-fenced location of attempted access, a geo-gridded location of attempted access, a time, a network address, a MAC address, and/or a device network card address and the first credential includes a passcode, a claim id, a shared password, a one-time password, a public key, and/or other secrets.

9. A system comprising:
at least one data processor;
memory storing instructions which, when executed by the at least one data processor, causes the at least one data processor to perform operations comprising:
receiving data characterizing a secure rights managed container including a first content holder, the first content holder including a first content, first terms and conditions, and a symmetric key, the first content encrypted by the symmetric key and configured to enable a modification of a blockchain, the first terms and conditions specifying access to the first content, and the symmetric key encrypted by a public key of a clearing server;
receiving a first context of a recipient and a first credential of the recipient;
determining, by the clearing server, access to the first content by the recipient at least by comparing the first terms and conditions to the first context and the first credential; and
providing the first content to the recipient for executing the modification of the blockchain.

10. The system of claim 9, wherein the providing further comprises:
decrypting, by the clearing server and using a private key of the clearing server, the symmetric key;
decrypting, by the clearing server and using the decrypted symmetric key, the first content; and
providing the decrypted first content to the recipient.

11. The system of claim 9, wherein the providing further comprises:
generating, by the clearing server, a session key between the recipient and the clearing server;
encrypting, by the clearing server and using the session key, the first content; and
providing the encrypted first content to the recipient.

12. The system of claim 9, wherein the memory storing instructions which, when executed by the at least one data processor, causes the at least one data processor to perform operations further comprising:
receiving data characterizing the first content and the first terms and conditions;
generating, by a generation server, the symmetric key;
encrypting, by the generation server, the first content;
encrypting, by the generation server and using the public key of the clearing server, the symmetric key;
packaging, by the generation server, the encrypted first content, the first terms and conditions, and the encrypted symmetric key into the first content holder; and
providing the secure rights managed container including the first content holder.

13. The system of claim 9, wherein the memory storing instructions which, when executed by the at least one data processor, causes the at least one data processor to perform operations further comprising:
executing the modification of the blockchain.

14. The system of claim 9, wherein the first content includes a first digital cryptocurrency unit of exchange, metadata, a first cryptocurrency address associated with the first digital cryptocurrency unit of exchange, a first private key associated with the first digital cryptocurrency unit of exchange, and/or supporting content for transmission between a sender and the recipient.

15. The system of claim 9, wherein the first terms and conditions include a passcode, a claim id, a geo-fenced location of attempted access, a geo-gridded location of attempted access, a time, a network address, a device network card address, a MAC address, a shared password, and/or other secrets.

16. The system of claim 9, wherein the first context includes a geo-fenced location of attempted access, a geo-gridded location of attempted access, a time, a network address, a MAC address, and/or a device network card address and the first credential includes a passcode, a claim id, a shared password, a one-time password, a public key, and/or other secrets.

17. A non-transitory computer program product storing instructions, which when executed by at least one data processor of at least one computing system, implement operations comprising:
receiving data characterizing a secure rights managed container including a first content holder, the first content holder including a first content, first terms and conditions, and a symmetric key, the first content encrypted by the symmetric key and configured to enable a modification of a blockchain, the first terms and conditions specifying access to the first content, and the symmetric key encrypted by a public key of a clearing server;
receiving a first context of a recipient and a first credential of the recipient;
determining, by the clearing server, access to the first content by the recipient at least by comparing the first terms and conditions to the first context and the first credential; and
providing the first content to the recipient for executing the modification of the blockchain.

18. The non-transitory computer program of claim 17, wherein the providing further comprises:
decrypting, by the clearing server and using a private key of the clearing server, the symmetric key;
decrypting, by the clearing server and using the decrypted symmetric key, the first content; and
providing the decrypted first content to the recipient.

19. The non-transitory computer program of claim 17, wherein the providing further comprises:
generating, by the clearing server, a session key between the recipient and the clearing server;
encrypting, by the clearing server and using the session key, the first content; and
providing the encrypted first content to the recipient.

20. The non-transitory computer program of claim 17, storing instructions, which when executed by at least one data processor of at least one computing system, implement operations further comprising:
receiving data characterizing the first content and the first terms and conditions;
generating, by a generation server, the symmetric key;
encrypting, by the generation server, the first content;
encrypting, by the generation server and using the public key of the clearing server, the symmetric key;
packaging, by the generation server, the encrypted first content, the first terms and conditions, and the encrypted symmetric key into the first content holder; and
providing the secure rights managed container including the first content holder.
